(19) United States
(12) Patent Application Publication
(10) Pub. No.: US 2015/0149284 A1
(43) Pub. Date: May 28, 2015

(54) METHOD AND SYSTEM FOR PROVIDING LOYALTY ENHANCED USER INTERFACE IN A FUEL DISPENSING ENVIRONMENT

(71) Applicant: Gilbarco Inc., Greensboro, NC (US)

(72) Inventors: Rodger K. Williams, Siler City, NC (US); Changzhong Jiang, Greensboro, NC (US); Edward A. Payne, Greensboro, NC (US); Travis J. Bouck, Kernersville, NC (US)

(21) Appl. No.: 14/553,582

(22) Filed: Nov. 25, 2014

Related U.S. Application Data
(60) Provisional application No. 61/909,053, filed on Nov. 26, 2013.

(51) Int. Cl. G06Q 30/02; G06Q 50/00

(52) U.S. Cl. CPC G06Q 30/0268; G06Q 30/0251; G06Q 30/0259; G06Q 30/0261; G06Q 30/0258; G06Q 50/01
USPC 705/14.56; 705/14.49; 705/14.57; 705/14.58; 705/14.65

(57) ABSTRACT

Systems and methods for managing loyalty applications in fuel dispensing environments are provided. At least one processor can execute a master mobile application comprising an interface for rendering content and/or accepting input. The master mobile application can be configured to communicate with one or more dispensing components to obtain parameters regarding product dispensing, display the parameters on a portion of the interface, and invoke a loyalty application for executing on another portion of the interface.

### PRIORITY CLAIM

This application is based upon and claims the benefit of provisional application Ser. No. 61/909,053, filed Nov. 26, 2013, which is incorporated fully herein by reference.

### TECHNICAL FIELD

The subject matter described herein relates generally to providing user interfaces executing loyalty applications at fuel dispensing or other retail locations.

### BACKGROUND

Today's fueling experience for the customer at a retailer involves selecting fuel grade, selecting payment type, fueling the vehicle, and returning the fuel nozzle when the desired amount is reached or the vehicle tank has reached capacity. The time during actual fueling of the vehicle often ranges from 2 to 10 minutes or more at times. During fueling of the vehicle it can be important to have the customer present to monitor the fueling process, which includes sale or volume, and to ensure that are no accidental fuel spillage happenings due to back wash or over-filling conditions. In addition, it can be desirable to engage the customer with additional information during this idle/fueling time by displaying content on the dispenser display (static or dynamic), attaching content to the dispenser with signage (static content), and/or possibly rendering content at a mounted separate dedicated display for dynamic content delivery.

Content deployed to monetize the customer fueling time or “fueling window,” such as advertisement and merchandising that also allow interaction by the customer to perhaps select coupons or menu items, has not met expectations due to high equipment costs versus return on investment (ROI), small scale, time and effort for managing media type, low quality, etc. Also, certain content, with virtually no analytics for predicating content that the customer will enjoy or even want to engage with, may annoy the fueling customer, which does not benefit the customer or the retailer. Also, loyalty programs in the past attempted to retain a fueling customer with offers like decreased price per gallon or discounts but has not evolved successfully and remains at best as a discount of a few cents off per gallon when used by the customer.

Recently, mobile applications for cell phones and other portable electronic devices are starting to be deployed with loyalty to engage the customer during the fueling experience. Often, these applications require a previous download of the specific application for the particular fueling brand to the customer's device by the customer before arriving at the fueling site. This also involves a signup process for the customer to complete for each different fueling brand or program, which can be rather cumbersome. Moreover, the signup process can be lengthy and often performed outside of the fueling site via a web page or mail, which even further decreases enrollment and participation. Today, retail fueling customers have a lot of hurdles to overcome such as signup for each new program, downloading and managing multiple applications, tracking key barcodes and magnetic strip cards, etc. to effectively participate in different programs. Having multiple mobile applications and loyalty cards are often confusing, provide different user prompting/experience when invoked, can only be used for the specific site or retailer, generally do not offer any more than a few cents of the price per gallon, etc.

All in all, the fueling customer's experience is often thought of as cumbersome, boring, and possibly annoying. This experience can subdue the retailers desire to capitalize additional value from a customer during the fueling window and even possibly frustrate the customer, which could deter the customer from going inside to purchase additional items or even cause the customer to avoid the site in the future.

### SUMMARY

The following presents a simplified summary of one or more aspects to provide a basic understanding thereof. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that follows.

Aspects described herein are directed to providing a master mobile application for executing on mobile devices present at a retailer to facilitate presenting content during product dispensing. The master mobile application can also be configured to display loyalty program information or other information specific to the retailer. For example, the master mobile application can invoke a loyalty application specific to a retailer (e.g., or a default application where the retailer does not provide a specific loyalty application) within the master mobile application. In this regard, for example, the master mobile application can execute on a customer device when the customer is at or near a retail location, and the master mobile application can invoke a loyalty program relating the retailer based on presence of the customer device at the retail location. In this example, the master mobile application can manage the loyalty application and/or related parameters with minimal interaction from the customer, and in some examples can also present at least one of content related to the retailer (whether via the loyalty application or otherwise), content that is otherwise intended to interest the customer during product dispensing, etc. In addition, for example, the master mobile application can facilitate automated acquisition of loyalty applications, automated registration for related loyalty programs, and/or the like to further minimize otherwise required customer interaction. This provides for a streamlined customer experience with respect to obtaining and managing loyalty applications and related rewards.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations may denote like elements, and in which:

FIGS. 1 and 2 are aspects of example systems for executing a master mobile application and a loyalty application.

FIG. 3 is an aspect of an example interface of a master mobile application and a loyalty application.

FIG. 4 is an aspect of an example methodology for invoking a loyalty application.

FIG. 5 is an aspect of an example methodology for invoking a loyalty application within a master mobile application.

FIG. 6 is an aspect of an example methodology for rendering content based on a detected level of customer presence.

FIG. 7 is an aspect of an example methodology for processing rewards for product dispensing based on social media networking activity.

FIG. 8 is an aspect of an example system in accordance with aspects described herein.

FIG. 9 is an aspect of an example communication environment in accordance with aspects described herein.

### DETAILED DESCRIPTION

Reference will now be made in detail to various aspects, one or more examples of which are illustrated in the accompanying drawings. Each example is provided by way of explanation, and not limitation of the aspects. In fact, it will be apparent to those skilled in the art that modifications and variations can be made in the described aspects without departing from the scope or spirit thereof. For instance, features illustrated or described as part of one example may be used on another example to yield a still further example. Thus, it is intended that the described aspects cover such modifications and variations as come within the scope of the appended claims and their equivalents.

Described herein are various aspects relating to providing a master mobile application for executing on a device during product dispensing at a retailer. For example, the master mobile application can be used to manage product dispensing at a retailer, and as such, for example, the master mobile application can maintain product dispensing parameters, such as customer preferences, payment options, past purchase preferences (e.g., at one or more retailers at which the master mobile application is executed), receipts, or other customer information, for use at one or more retailers. For example, the master mobile application can execute on a personal device, such as a mobile device, vehicle information system, etc. In addition, the master mobile application can invoke at least one of a plurality of retailer-specific or default applications, such as loyalty applications, during product dispensing. Where the master mobile application cannot access a loyalty application for the retailer, the master mobile application can download the related application (e.g., where download information is obtainable), and/or execute a default loyalty application.

In one example, the master mobile application can execute the loyalty application based on a received or detected trigger. The trigger can include detecting a location of a device (e.g., via GPS or other receiver within or in communication with the personal device) at the retailer, receiving a near-field communication (NFC), Bluetooth, WiFi, or other detectable message at the retailer, scanning a QR code upon entering the premises of the retailer, and/or the like. The trigger can also allow for identifying the retailer, and the master mobile application can utilize this information to obtain the appropriate loyalty application or other retailer-specific (or default) content. In addition, the master mobile application can embed the loyalty application such to retain control over whether the loyalty application or other content is displayed on an interface by the master mobile application.

In this regard, for example, the master mobile application can provide, in addition or alternatively to the loyalty application, content and/or allow interaction regarding product dispensing, which can include providing product discounts, processing payment for the product, etc. In further examples, the master mobile application can track participation with the master mobile application to determine at least one of discounts to provide for the product dispensing in return for participating with the content, content for providing via the master mobile application, and/or the like. In other examples, the master mobile application can facilitate interfacing with social media networks to allow the customer to interact therewith regarding product dispensing. Moreover, in an example, the master mobile application can determine content for presenting (e.g., in a current or future execution of the master mobile application or loyalty application) based at least in part on the social media network interaction.

As used in this application, the terms “component,” “module,” “system,” “device” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, the subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it is to be appreciated that a carrier wave can be employed to carry computer-readable electronic data such as those used in transmitting and receiving electronic mail or in accessing a network such as the Internet or a local area network (LAN). Of course, those skilled in the art will recognize many modifications can be made to this configuration without departing from the scope or spirit of the subject matter.

Moreover, the term or is intended to mean an inclusive or rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and an as used in this application and the appended claims should generally be construed to mean one or more unless specified otherwise or clear from the context to be directed to a singular form.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

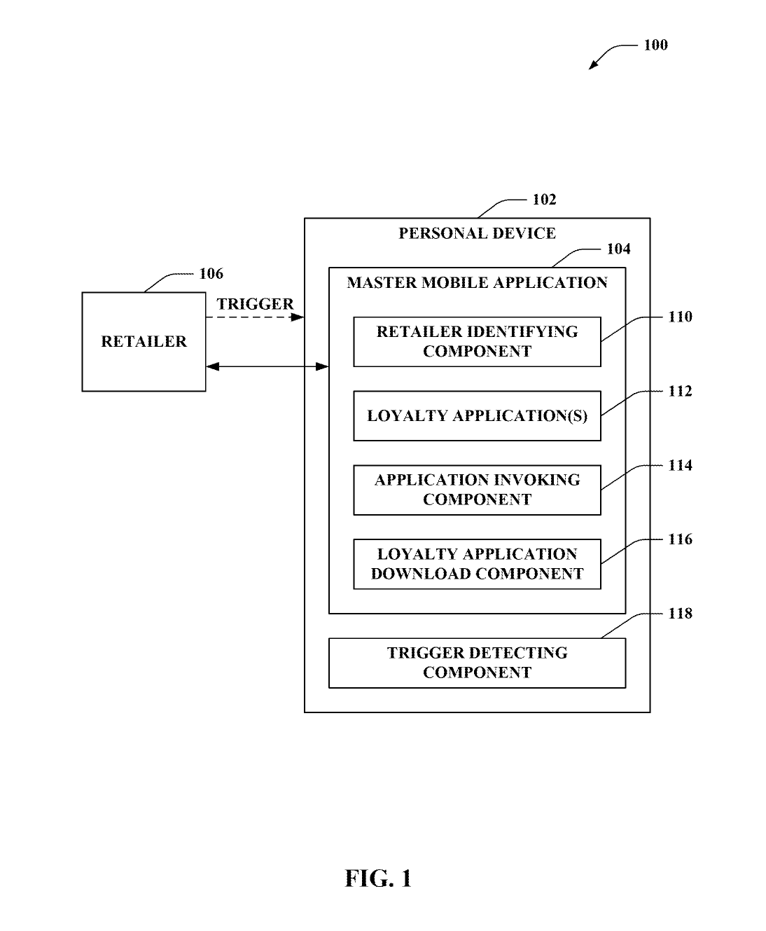

FIG. 1 illustrates an example system 100 for executing a master mobile application when at or near a retailer. System 100 includes a personal device 102 for executing a master mobile application 104 at least when at or near a retailer 106. Personal device 102 can include a mobile device (e.g., a cellular phone, tablet, or other computing device that can communicate in a mobile or wireless network), a vehicle information system, and/or the like. Personal device 102 can also include a trigger detecting component 118 for detecting a trigger relating to presence of the personal device 102 at or near retailer 106. In one example, personal device 102 can have one or more wireless radios for receiving communications directly from one or more devices at retailer 106, such as a NFC radio, a Bluetooth radio, a WiFi radio, and/or the like, and the trigger detecting component 118 can receive communications from the one or more wireless radios to detect presence of the personal device 102 at the retailer 106. In another example, trigger detecting component 118 can detect a scan of a QR or bar code at the retailer 106 for determining presence at the retailer 106. Retailer 106 can relate to a retail site for product dispensing, and can include one or more components that facilitate product dispensing, providing dispensing information or other content to dispensers or other devices, processing payment transactions or providing other point-of-sale (POS) functionality, and/or the like.

Master mobile application 104 can include a retailer identifying component 110 for identifying one or more retailers within range of the personal device 102, one or more loyalty application(s) 112 for corresponding to one or more retailers (e.g., specific loyalty applications related to the retailers, a default application for retailers not having a specific loyalty application, etc.), an application invoking component 114 for executing the loyalty application 112 based on one or more detected parameters, and a loyalty application download component 116 for downloading a loyalty application for the retailer 106. Thus, for example, application invoking component 114 can invoke the loyalty application 112 for executing within master mobile application 104 (e.g., in a wrapped window). Thus, in one example as described further herein, the master mobile application 104 can embed the loyalty application 112 for executing on the same interface of personal device 102. It is to be appreciated that the loyalty application 112 can include applications for managing loyalty rewards for related retailers or other retailer-specific applications, such as an in-store ordering application for placing orders for items in a store of the retailer (e.g., food, drinks, etc.).

According to an example, trigger detecting component 118 can detect a trigger at or from retailer 106, which can cause personal device 102 to execute master mobile application 104 and/or send information related to retailer 106 to master mobile application 104 for obtaining retailer-specific content/applications. For example, retailer 106 can include one or more components that transmit one or more signals to indicate information regarding retailer 106, such as an NFC transmission, a Bluetooth transmission, a WiFi transmission, etc., which the personal device 102 can receive via one or more wireless radios when within range using one or more associated radios to receive the transmission, and trigger detecting component 118 can determine whether a received signal is a trigger from an identifiable retailer. The one or more components transmitting the signals can include a product dispenser, a handheld device at an attended dispensing site, or other components that can transmit signals and/or interface with retailer-specific systems. In one example, the transmission can include information regarding the retailer, such as a retailer and/or franchise identifier, a location identifier, a resource identifier related to a loyalty application for the retailer 106 (e.g., to download and/or launch the loyalty application), and/or the like. In this example, trigger detecting component 118 can determine the trigger is related to a retailer and can provide information of the trigger to master mobile application 104. Retailer identifying component 110 can identify the retailer 106, whether as the organization itself, a specific location or franchise, etc., for invoking a loyalty application or other content related to the retailer 106 (whether related to the organization itself, a specific location or franchise of the retailer 106, etc.).

Retailer identifying component 110, in this regard, can determine an identity related to the retailer 106 based at least in part on the information received in the trigger from retailer 106 or otherwise determined based on the trigger. For example, the information can include an identifier of the retailer 106 or specific location/franchise (and/or a specific dispenser at the retailer 106), as described, a resource identifier of a related loyalty application for downloading or otherwise executing the application, location information of the retailer 106, etc. In another example, retailer identifying component 110 can obtain location information from personal device 102 (e.g., as obtained from a GPS receiver, mobile network triangulation, and/or the like), based on receiving the trigger or otherwise, and can determine an identity of retailer 106, a resource identifier of a related loyalty application, etc. based on the location information. In one example, in this regard, retailer identifying component 110 can include or can access information correlating location (e.g., GPS coordinates, street address, etc.) to retailer 106 information. In addition, in one example, trigger detecting component 118 can detect a trigger based on location change (e.g., as determined from a GPS receiver, triangulation, etc.), and can determine whether the personal device 102 is near one or more retailers 106 based on determining the location of personal device 102.

In an example, application invoking component 114 can invoke a loyalty application 112 related to the retailer 106 information for operation by master mobile application 104. In an example, application invoking component 114 can include or can access information correlating retailer 106 information to one or more loyalty applications. For example, this information may include an identifier of a loyalty application 112 stored on personal device 102 (e.g., in a registry correlating retailer identifiers to stored loyalty applications), an identifier for downloading a loyalty application (e.g., from or at the retailer, from an app store, etc.), and/or the like. In addition, in an example, the retailer 106 information can include a resource identifier for downloading the loyalty program if needed. Thus, in one example, where a loyalty application correlated to the retailer 106 information is not accessible on personal device 102, loyalty application download component 116 can download the loyalty application for the retailer 106. For example, loyalty application download component 116 can download the loyalty application using an internet connection of the personal device 102, a connection with retailer 106 (e.g., via NFC, Bluetooth, WiFi, etc., which may or may not be the same connection over which the trigger is received), and/or the like. Once downloaded, application invoking component 114 can invoke the loyalty application 112 for operation by master mobile application 104.

In addition, in an example, where application invoking component 114 cannot locate information correlating retailer 106 information to a loyalty application, application invoking component 114 can invoke a default loyalty application 112 for operation by master mobile application 104. For example, a retailer-specific loyalty application can be developed by the retailer for providing various retailer-specific content, transaction interfacing (e.g., to obtain loyalty rewards), offer enrollment, in-store product purchasing, discounts or other rewards, and/or the like. A default loyalty application may allow for providing loyalty-type attributes related to product dispensing, such as dispensed product discounts.

Master mobile application 104, in an example, can present content and/or allow interaction relating to product dispensing at retailer 106. In this regard, in an example, master mobile application 104 can communicate with one or more components of retailer 106 to provide information relating to product dispensing, transaction payment, advertising (e.g., in-store or otherwise), product surveys, and/or the like. It is to be appreciated that master mobile application 104 can obtain the content and/or provide input as part of customer interaction from/to a content server, product dispenser, POS terminal, etc., at or accessible by retailer 106. Again, as described, master mobile application 104 can communicate with the one or more components of retailer 106 over a connection between personal device 102 and the one or more components (e.g., via NFC, Bluetooth, WiFi, cellular network, etc.). In an example, master mobile application 104 can render on an interface to wrap the loyalty program, such that the master mobile application 104 portion of the interface may appear familiar on the personal device 102 regardless of the retailer 106 visited, but the loyalty application or other retailer-specific content may appear differently depending on the retailer 106.

In an example, where the customer has not yet signed up for a loyalty program related to the loyalty application 112, master mobile application 104 can also at least partially facilitate automatic signup for the loyalty program. For example, the automated signup can include providing requested information based on the one or more stored customer preferences. For example, master mobile application 104 can at least partially indicate customer information to the loyalty application 112 based on the stored preferences (e.g., name, address, payment information, etc.) to complete at least a portion of the signup process. In one example, master mobile application 104 can initiate the signup process based on application invoking component 114 invoking the loyalty application 112 and receiving a request or indication to signup from the loyalty application. In an example, the master mobile application 104 can prompt the customer whether to enroll in the loyalty program, and can initiate the automated signup based at least in part on a response to the prompt. Master mobile application 104, in this regard, can manage the multiple loyalty application(s) 112 and can also manage related information, such as account numbers for the loyalty applications, account balances, outstanding offers, and/or the like. Furthermore, in an example, master mobile application 104 can provide details of product dispensing to loyalty application 112 so that loyalty application 112 can compute or otherwise obtain loyalty awards for the customer based on the product dispensing.

In another example, invoking of the loyalty application 112 can be a selectable option (e.g., a configuration parameter specified in the master mobile application 104, a response to a prompt presented by the master mobile application based on detecting the trigger, etc.). In this regard, where application invoking component 114 does not invoke a loyalty application based on a selection to not invoke, master mobile application 104 may display other content in an area where the loyalty application would otherwise execute (e.g., ad content, games, etc.). As described, the master mobile application 104 can retain control of the loyalty application 112 by embedding the loyalty application 112 within a window or other interface portion rendered on behalf of the master mobile application 104. In one specific example, application invoking component 114 can be or can include an emulator that functions to window the loyalty applications 112 otherwise executable on one or more devices while also retaining control of presenting the loyalty applications 112. Thus master mobile application 104 can additionally perform the other functions in the background (or foreground), such as product dispensing management, etc., as described further herein. In this regard, for example, application invoking component 114 can display, hide, reframe, etc. loyalty applications 112 at various times to allow for displaying content relating to the master mobile application 104, such as advertisements, product dispensing details, and/or the like.

In a specific example, the retailer 106 can be a retail fueling station, which can include a store operated by the retailer, fuel dispensers installed by a manufacturer thereof, etc. In an example, master mobile application 104 can be provided by the manufacturer of the fuel dispensing components to facilitate interaction therewith and/or with related components. In any case, the master mobile application 104 can be a single application or framework that may reside on a customer's personal device 102. The master mobile application 104 can manage and maintain customer preferences, payment options if any, past purchase preferences, receipts and other customer personal information that the customer sets. These preferences can be used by master mobile application 104 during fuel dispensing at the retailer 106 (e.g., in automatically selecting a grade of fuel to dispense as part of a transaction, determining payment parameters when processing payment for the transaction, recalling receipts for the transactions, and/or the like). In addition, as describer further herein, the master mobile application 104 can perform various functions to facilitate providing content to the customer, tracking customer participation, offering discounts or rewards (e.g., based on the customer participation), and/or the like. The master mobile application 104 can perform such functions while also using application invoking component 112 to execute an emulator or other mechanism to execute one or more loyalty applications 112, which can be triggered when present at a related retailer 106 location, as described.

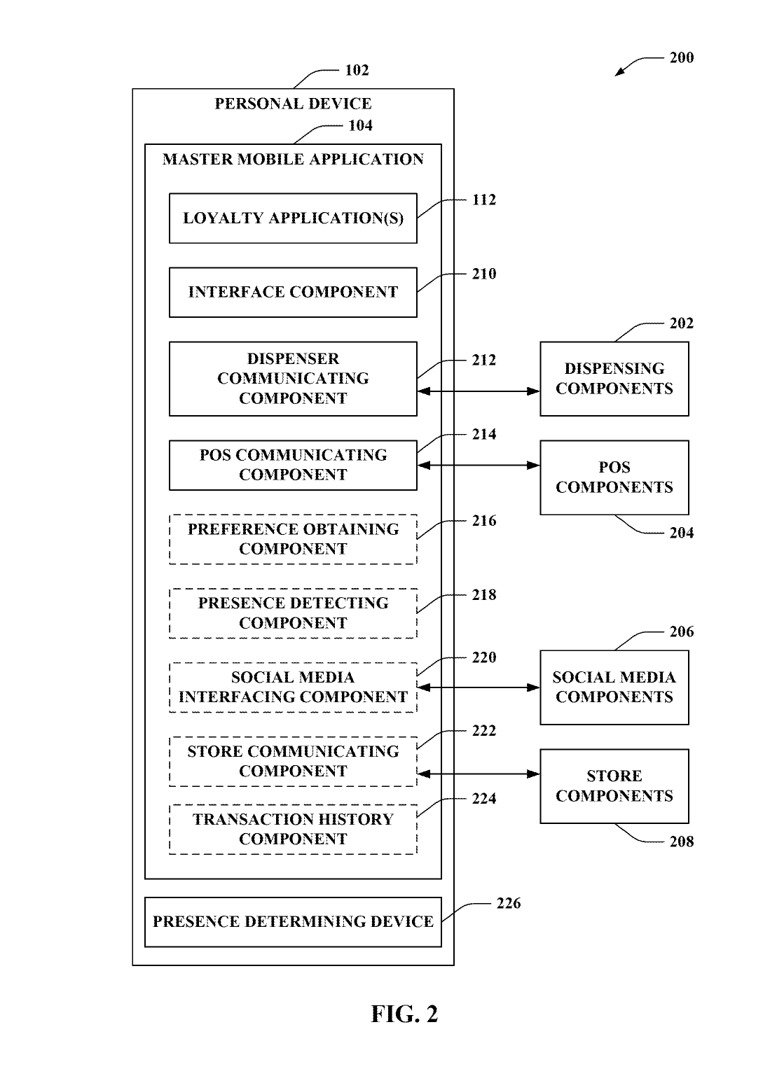

FIG. 2 illustrates an example system 200 for executing a master mobile application 104 in accordance with aspects described herein. In addition to the various components illustrated in FIG. 1 for determining and executing a loyalty application, the personal device 102 and master mobile application 104 can include additional components related to operation of the master mobile application 104 itself and/or in conjunction with the loyalty application. For example, master mobile application 104 can execute one or more loyalty applications 112, as described, and can include an interface component 210 for displaying content, obtaining input, and/or the like, a dispenser communicating component 212 for communicating information regarding product dispensing with dispensing components 202, and a POS communicating component 214 for communicating transaction information with POS components 204. Master mobile application 104 also optionally includes a preference obtaining component 216 for retrieving one or more preferences specified in the master mobile application 104 (e.g., by a customer using the master mobile application 104), a presence detecting component 218 for determining whether a customer is present at, or otherwise interacting with, the master mobile application 104 (or a loyalty application 112), a social media interfacing component 220 for communicating with one or more social media components 206 of a social media system, a store communicating component 222 for communicating with one or more store components at a convenience store, and a transaction history component 224 for storing details of product dispensing transactions. Personal device 102 can include a presence determining device 226 from which preference detecting component 218 can obtain information for determining a level of presence of a customer at the personal device. For example, presence determining device 226 can include a camera, proximity sensor, motion sensor, facial recognition or eye gaze tracking device, and/or the like.

As described, for example, master mobile application 104 can execute a loyalty application 112, which interface component 210 can display in a window or other interface portion embedded within or separate from one or more other windows or interface portions for other functions of the master mobile application 104. Interface component 210, for example, can provide output and/or accept input related to functions of the master mobile application 104 described herein, while also allowing execution of the loyalty application 112, which can also provide output and/or accept input in an embedded or separate window. Thus, in an example, master mobile application 104 can in essence host the loyalty application 112, such that master mobile application 104 can interrupt the loyalty application 112, overlay content on the loyalty application 112, resize or hide the interface portion dedicated to the loyalty application 112, and/or the like. As described, for example, master mobile application 104 can include an emulator for executing the loyalty application 112 and can control the emulator to achieve desired functions with respect to the loyalty application 112 and other functions provided by the additional components of the master mobile application 104. In addition, it is to be appreciated that the dispensing component 202, POS components 204, and store components 208 can be present at the retailer (e.g., retailer 106) where the master mobile application 104 is operating or can at least communicate with certain other components at the retailer to provide or obtain information regarding product dispensing, product payment, store inventory or purchasing, and/or the like.

In one example, interface component 210 can display information related to product dispensing, such as an amount of product dispensed, a price per unit, a total price, a product dispenser identifier, and/or the like. In this regard, for example, dispenser communicating component 212 can communicate with dispensing components 202, such as the dispenser itself, a handheld device at an attended dispensing site, one or more components at a retailer that communicate with or otherwise manage dispensers, and/or the like. Dispenser communicating component 212 can communicate with the dispensing components 202 using local wireless communications, such as NFC, Bluetooth, WiFi, etc. at the retailer, over a cellular network, and/or the like. Interface component 210 can accordingly display information regarding product dispensing as obtained by dispenser communicating component 212. In one example, dispenser communicating component 212 can determine one of the dispensing components 202 within the retailer with which to communicate based on a determined location of the personal device 102, a received NFC, Bluetooth, or other near range signal, and/or the like.

POS communicating component 214 can similarly communicate with POS components 204 at the retailer over one or more local wireless communication mediums, cellular network, etc., to obtain and/or provide transaction payment information. POS components 204 can include a POS terminal, a handheld device at an attended dispensing site, one or more components at a retailer that communicate with or otherwise manage POS terminals, and/or the like. For example, POS communicating component 214 can provide transaction payment details, such as a credit card number, PIN, zip code, etc., to the POS component 204 for processing payment. In an example, the transaction payment details can be entered via interface component 210 (e.g., by the customer), and/or can be provided by the master mobile application 104 based on stored payment preferences (e.g., as stored and obtained by preference obtaining component 216, inferred based on one or more transactions stored by transaction history component 224, etc.). In a similar example, the interface component 210 can be used to authorize payment using certain stored transaction payment details, which causes the POS communicating component 214 to provide the transaction payment details to POS components 204. POS components 204 can provide a response (e.g., transaction authorization, denial, or other information) back to the POS communicating component 214, and the interface component 210, in an example, can display information based on the response. In one example, preference obtaining component 216 can retrieve the transaction payment details input by the customer (e.g., via interface component 210 or other input device that stores information to which master mobile application 104 has access). In any case, transaction history component 224 can store transaction details, such as a receipt or related information (e.g., payment information provided to the POS components 204, dispensing amounts, product type (e.g., fuel grade selection), whether additional items are purchased (e.g., car wash), etc.), a location of the retailer 106, and/or the like. Thus, master mobile application 104 can provide transaction tracking information, receipt recall or printing, statistical information regarding various transactions, and/or the like, based at least in part on the stored transaction details. In addition, in another example, preference obtaining component 216 can infer customer preferences based at least in part on the transaction details stored by transaction history component 224.

In addition, for example, presence detecting component 218 can determine customer presence with respect to the master mobile application 104. For example, presence detecting component 218 can interface with the presence determining device 226, which can include one or more of a camera, proximity sensor, motion sensor, facial recognition or eye gaze tracking device, etc. In this regard, for example, presence determining component 218 can determine a level of presence of a customer, e.g., whether a customer is in front of, looking at, etc. master mobile application 104, based on information received from the presence determining device 226. For example, presence detecting component 218 can receive data from a proximity sensor to determine whether an object is within a specified distance of the proximity sensor, data from a motion sensor to determine whether motion is occurring before the sensor, data from a facial recognition device to determine whether a face is detected in one or more regions, data from an eye gaze tracking device to determine whether a customer is looking at the personal device, image data from a camera from which facial recognition, eye gaze, etc. can be analyzed to determine whether the customer is looking at the master mobile application 104, etc. Master mobile application 104, in this regard, can select content, compute discounts, etc. based at least in part on the presence data detected by presence detecting component 218. It is to be appreciated that presence detecting component 218 can analyze the level of presence based on detecting presence at certain times, detecting continuous presence over a period of time, etc.

In one example, social media interfacing component 220 can communicate with social media components 206 of a social media network to facilitate communicating information from master mobile application 104 to the social media network. In one example, interface component 210 can allow the customer to post status updates or similar content to the social media network. In an example, available status updates can be limited to certain updates regarding the transaction. The master mobile application 104 may apply discounts for product dispensing based on the interaction with the social media network (e.g., based on a number of status updates, the content of one or more status updates performed at the retailer, and/or the like). In another example, the loyalty application 112 can apply rewards or other incentives for the customer based on social media interfacing component 220 interacting with the social media components 206 to post status updates, etc., and notifying the loyalty application 112 of the interaction. In other examples, interface component 210 can provide an option for the customer to indicate an approval for the retailer (e.g., a “like” or “+1”) using the social media network, and master mobile application 104 can determine to apply a product discount after a number of approvals are indicated by the customer (e.g., at a certain retailer or one or more retailers, etc.). It is to be appreciated that master mobile application 104 or loyalty application 112 can track interaction with the social media network via social media interfacing component 220 to determine when to offer discounts. In other examples, the social media network can track the interactions and notify master mobile application 104 of available discounts for the customer, etc.

In another example, store communicating component 222 can interact with one or more store components 208 at the retailer to obtain information regarding a convenience store at the retailer. For example, store communicating component 222 can obtain information regarding inventory of the store, obtain a list of menu items for purchase in the store, which can be rendered using interface component 210. In this example, interface component 210 may allow purchase of in-store items (e.g., via loyalty application or master mobile application). In an example, the purchased items can be added to the dispensed product purchase, and thus the master mobile application 104 can update a total price including the dispensed or dispensing product and purchased items on interface component 210. In another example, POS communicating component 214 can communicate with POS components 204 to separately process payment for the purchased items. In one example, a store employee can deliver purchased items to the customer. In another example, store communicating component 222 can determine one or more discounts for offer on items in the store, which can be rendered and/or redeemed using interface component 210, and/or the like.

In one example, store communicating component 222 can allow for purchasing and managing lottery tickets. For example, interface component 210 can display an interface allowing selection of lottery ticket purchase (e.g., including selection of ticket type, number selections, quantity specification, etc.). Store communicating component 222 can communicate the lottery ticket information to store components 208 to facilitate ticket purchase via master mobile application 104. In one example, the customer can pickup the tickets in the store, obtain the tickets from a printer on the device executing the master mobile application, a printer at the dispenser, and/or the like. In another example, the tickets need not be printed, and store communicating component 222 can retain an electronic version of the ticket. In any case, store communicating component 222 can allow for tracking the ticket via master mobile application 104 to determine whether tickets have payout following number draw. If so, store communicating component 222 can communicate with store components 208 at a subsequent visit to facilitate obtaining payouts (e.g., as a transaction credit, cash, or otherwise).

In one example, as described, master mobile application 104 can operate at fuel dispensing retailers for providing an application that displays information regarding fuel dispensing, loyalty program information for various fueling stations, etc. In an example, the master mobile application 104 can execute loyalty application(s) 112 using an emulator such that the master mobile application 104 can interrupt the loyalty application 112 by managing the emulator at various stages within the fuel dispensing to render other content (whether related to the retailer or not) and/or facilitate interaction therewith, such as advertisements, soliciting fuel discounts (e.g., in exchange for viewing advertisements), product dispensing measurements, price per unit, total price, social media interaction, and/or the like, as described herein.

In one example, the master mobile application 104 can interact to offer tiered price discounts on product dispensing via interface component 210 dependent on one or more selections. For example, the one or more selections can correspond to customer choice of money back, total discount from fuel sale, and/or the like, if the fueling customer wishes to participate in viewing certain advertising content, etc. For example, options can be provided as to content length and associated discount amounts. Customer participation in viewing the advertisements can be monitored by presence detecting component 218, as described. Thus, the customer can view the advertisement and, where a determination as to level of participation in viewing can be performed by presence detecting component 218 for example, master mobile application 104 can process discounts on the product dispensing.

For instance, interface component 210 can display discounts, whether per unit, a total purchase discount, etc., which can be displayed as a running total as the advertising content in viewed. For instance, the interface component 210 can display the discounts as a status bar (e.g., overlaid on the advertisement), which may include a running total of the discount as the advertisement is rendering (e.g., where the advertisement is awarded based on a portion of the advertisement rendered and/or viewed). In another example, dispenser communicating component 212 can provide discount information to the dispensing components 202, which can update a dispenser to show the processed discount (whether per unit or on a total amount), and/or the like. Thus, in one example, where the dispensing components 202 relate to fuel dispensers, the dispensers can display the discounted price per grade as the fuel is dispensing and/or as the advertisement continues to render via interface component 210 (and/or as the presence detecting component 218 continues to determine the customer is viewing the advertisement).

In some examples, however, the master mobile application 104 may not have access to the dispensing components 202 and/or POS components 204 and can thus generate discounts or rewards for redemption after the transaction (or at least after product dispensing). In this example, master mobile application 104 can provide information of the discount via interface component 210 and/or can provide for redemption of the discounts using various mechanisms. In one example, the interface component 210 can display a QR code or other code for scanning at a POS terminal that allows redemption of at least a portion of the discount. In another example, store communicating component 222 can otherwise communicate the discount to one or more store components 208 at the retailer or other retailers for redeeming. In both instances, for example, the retailer can reconcile the discount with an entity associated with the master mobile application 104. In other examples, social media interfacing component 220 can provide discount details to social media components 206 or other online services, allowing the customer to at least one of: retrieve the discount at an online merchant; redeem a cash value of the discount using a financial transaction service; donate the discount to another person (e.g., as a user of a social media network or otherwise) as a discount at a specific retailer (e.g., as a gift card, whether at the retailer related to the product dispensing or a different retailer) or as cash; donate the discount to a cause (e.g., as a cash or merchandise discount); and/or the like. Moreover, in this example, master mobile application 104 may allow stacking rewards obtained at multiple retailers into a single discount or reward obtainable at a single retailer.

In another example, where the customer recently registered or otherwise visits a retailer at which the customer is not a loyalty program member, the master mobile application 104 may offer a larger one time discount for product dispensing (or other incentives) if the customer agrees to join the retailer's loyalty program. This discount can be similarly reflected on interface component 210, communicating to dispensing components 202, and/or the like.

The master mobile application 104 may also provide the customer options of varying discounts depending on active participation with certain content on master mobile application 104. For example, as described, master mobile application 104 can determine participation for items like surveys based on input via interface component 210, and/or for items such as advertisements based on utilizing presence detecting component 218 to detect presence (or a level of presence or interaction) of the customer as described previously. The master mobile application 104 may also have the feature to abandon or limit the discount offered to the customer where the interface component 210 detects the customer exiting the rendered content (e.g., by closing a window rendered by interface component 210), detects the customer looking away from the device executing the master mobile application 104 (e.g., as determined by presence detecting component) throughout the fueling time or at least for a minimum amount of time. The price difference can be adjusted in real-time or adjusted post fueling when the nozzle is returned to the holster based on activity or lack thereof with the master mobile application 104 during fueling.

In other examples, the master mobile application 104 can facilitate customer prompting via interface component 210 based on one or more parameters obtained by preference obtaining component 216, such as customer information, past fueling behavior, etc. and may also invoke those fueling preferences to reduce the pre-fueling required activities prior to authorization (e.g., multiple dispenser touch points like grade select, payment type, car wash, etc.). In this example, dispenser communicating component 212 can provide dispensing related parameters obtained by preference obtaining component 216 to dispensing components 202 to facilitate product dispensing based on the parameters. As described, the preference obtaining component 216 can determine the preferences based on prompting the customer via interface component 210, inferring the preferences based on inputs processed via interface component 210 in previous fuel dispensing, etc. Similarly, in an example, POS communicating component 214 can provide payment related parameters obtained by preference obtaining component 216 to POS components 204 to facilitate transaction payment processing based on the parameters. The master mobile application 104 may also utilize the one or more parameters obtained by preference obtaining component 216 in determining targeted advertising for the customer for rendering on the interface component 210. In addition, where the dispensers are capable of rendering content, dispenser communicating component 212 can communicate the advertising to dispensing components 202 for display.

The master mobile application 104 may also determine interest, participation, etc. in the master mobile application 104 and/or loyalty application 112 by monitoring eye movement obtained using presence detecting component 218. In addition, in an example, presence detecting component 218 can obtain input from other present determining device 226 components, such as readings from an accelerometer, certain detected touch inputs, etc. from which a level of participation can be determined. Master mobile application 104 can utilize this information to change content rendered on interface component 210, dispensing components 202 via dispenser communicating component 212, etc. based on the fueling customer's perceived viewing or interaction interest level during fueling. Other items may cause the master mobile application 104 to invoke any of the above mentioned actions such as presence detecting component 218 detecting, via presence determining device 226, initiating of a phone call on the device, texting by the customer on the device, etc. The master mobile application 104 may also render these activities within a windowed environment on interface component 210 to allow the customer to continue receiving the cost incentives at present values while texting or calling is taking place on the device.

In further examples, the master mobile application 104 may also solicit social media customer input via interface component 210 during fueling in exchange for discounts or specials on fuel or other items. The master mobile application 104 can then relay those inputs such as likes and tweets to the respective social media network on the customer's behalf if a media account is held by the customer or in an anonymous way by communicating with social media components 206 using social media interacting component 220. For example, the social media interacting component 220 can access one or more interfaces of the social media components 206 to utilize various functions of the social media networks. As described, the master mobile application 104 may also apply rewards or stored discounts to be redeemed later or after certain accumulation amounts have been reached based on the social media network interactions. In one example, master mobile application 104 can apply the rewards or discounts by automatically obtaining lottery tickets, movie tickets, restaurant specials, etc., for delivering to the customer (e.g., via a printer at the retailer by communicating reward or discount information to dispensing components 202 or POS components 204, by crediting an account of the customer that can be linked at the retailer or related movie theater, restaurant, etc. for off-site redemption, and/or the like). The master mobile application 104 may also allow the customer to transfer the rewards or discounts to another master mobile application 104 user or social media network user by using interface component 210 and/or one or more interfaces provided by the social media network, as described. This can be used to promote brand awareness for which the fueling customer can be rewarded by the actions described above or otherwise (e.g., such a free fill up) by the master mobile application 104 or loyalty application 112.

In addition, in some examples, the master mobile application 104 may continue interfacing with the customer and/or providing retailer value any time after the fueling transaction for which the fueling customer may gain additional incentives and rewards. For instance, the retailer may reward the customer via by the master mobile application 104 or the loyalty application 112 once the customer registers 100 “likes” or other approvals for the retailer using social media interfacing component 220, once the customer's social media friends have a number of posts regarding the retailer in question, etc. Thus, brand marketing for the retailer via the customer through social media can result in rewarding the customer.

Additional derived benefits for the retailer in addition to the ones above are possible as well, including compensation for the customer for allowing advertised content to be offered via interface component 210 at their site during the fueling window, where the compensation can be at or above any discounts offered to the their customer during the fueling window. Additional compensated discounts that can be verified by the master mobile application 104 during fueling for items selected by providers of certain merchandise such as a soft drink company, a candy company, etc. for purchase of the merchandise in the store. For example, the additional compensated discounts can be received by store communicating component 222 from store components 208 (e.g., over NFC, Bluetooth, WiFi, mobile network, or other communication medium). In addition, the discounts may be similar to a coupon, but can be verifiable to the merchant that the customer purchased the merchandise from the retailer during or after the fueling experience, which can be verified by the master mobile application 104 based on a purchase confirmation received via store communicating component 222 from store components 208, for example.

According to examples described herein, the master mobile application 104 can provide instant loyalty program signup (e.g., via loyalty application 112 or otherwise using another service), loyalty application 112 download and immediate use at the fueling site (whether the loyalty application is specific to the retailer or a default application), and/or the like. The master mobile application 104 can also provide confirmed targeted or non-targeted content/media opportunities on a customer's device based on customer preferences, past behavior, etc., as determined and stored by preference obtaining component 216, with view confirmation in return for retailer incentives (e.g., scaled price per gallon or end sale discount based on content viewed, interaction, merchandising response, etc.). Master mobile application 104 also provides multiple loyalty application management with instant activation based on customer preferences and site triggers (e.g., location-based triggers, signaled triggers, etc.). Moreover, master mobile application 104 can provide a framework wrapper around the third party loyalty application to include a dashboard of sale/volume display for dispensing the product, cancel dispensing, etc. while also displaying content related to the loyalty application. Master mobile application 104 also offers media outlets a viewing of at least two or more minutes with presence detection mechanisms in addition to specific opt-in customer attributes for refining and generating content of interest to the end fueling customer. Master mobile application 104 can further provide global impact because additional specific hardware may not be needed at the retailer, other than an NFC tag, as an attended handheld can supply other functions, as described herein. Moreover, a customer receives value in the master mobile application 104 by reduction in current loyalty program requirements, such as magnetic strip cards, fobs, key tags etc. and consolidation into a single automated asset for the customer.

In other examples, the master mobile application 104 can also stack multiple loyalty rewards accumulated by the customer for retailers/merchants for applying multiple discounts via interface component 210, as described. Interface component 210 can present options for certain dispenser activities, such as fuel stoppage and restart if the customer is away or inside the store, which can notify of possible fuel theft from the fueling customer by another person, options to take such as fueling resume, quit, activate car alarm, etc. The options can be effectuated on dispensing components 202 via dispenser communicating component 212, as described. Moreover, in an example, the master mobile application 104 can alter fuel rate depending on customer location. For example, presence detecting component 218 can determine the customer is away from the device (e.g., where the device is a vehicle information system), or can determine that the device (and thus the customer) is away from the vehicle, in the retail store, etc., and can slow fuel rate (e.g., to 5 gallons-per-minute from 10 gallons-per-minute) by communicating with dispensing components 202 as described.

In other examples, the master mobile application 104 may also window mobile games via interface component 210 while displaying fueling status. The master mobile application 104 can also assist the fueling customer by requesting assistance (call the site) from site personnel for instances such as handicap assistance or dispensing accidents. For example, store communicating component 222 can indicate an assistance request or accident to store components 208 for rendering to a clerk in the store. This can be based on a request for assistance by the customer via interface component 210.

Additionally, in some examples, the master mobile application 104 can also facilitate signing on to one or more WiFi or other wireless technology networks at the retailer. In one example, the wireless networks at the retailer can be secured with encryption known only by master mobile applications 104. Moreover, the master mobile application 104 can also be deployed in attended markets by allowing the site attendant to provide a handheld to the vehicle occupant to install the loyalty application 112 and/or master mobile application 104 to monitor fuel sale, volume, etc.

Master mobile application 104 can further, in an example, generate a QR code, bar code, or similar identifier for conveying loyalty program information of the customer (e.g., a loyalty account number) via interface component 210. For example, interface component 210 can render the code based on master mobile application 104 detecting the trigger of the retailer, and the code can be scanned at the retailer to associate the customer loyalty account with a current transaction.

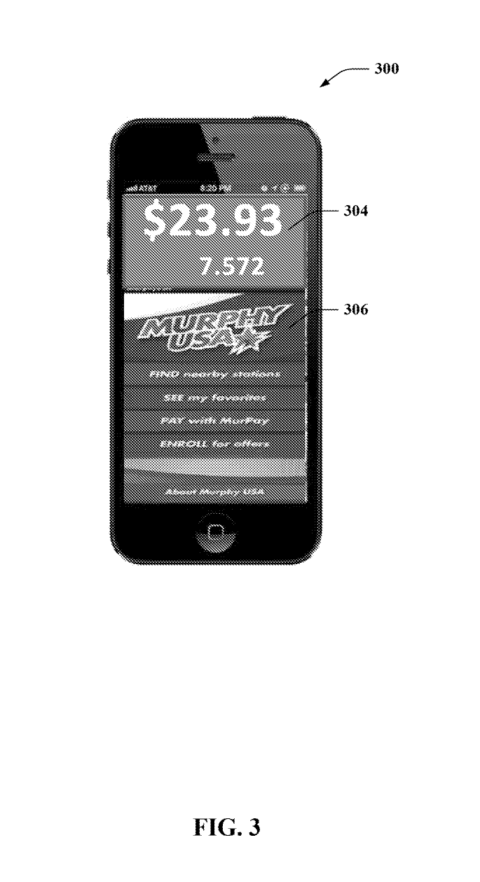

FIG. 3 illustrates an example device 300 that includes an example interface having a fuel dispensing portion 304 and a loyalty application portion 306. As described, for example, the device 300 can execute the master mobile application that provides the dispensing application portion 304 on an interface of the device 300, and can also wrap the loyalty application 306 for simultaneous display on the interface. Thus, the customer can interact with the loyalty application portion 306 while also viewing details of fuel dispensing in the dispensing application portion 304.

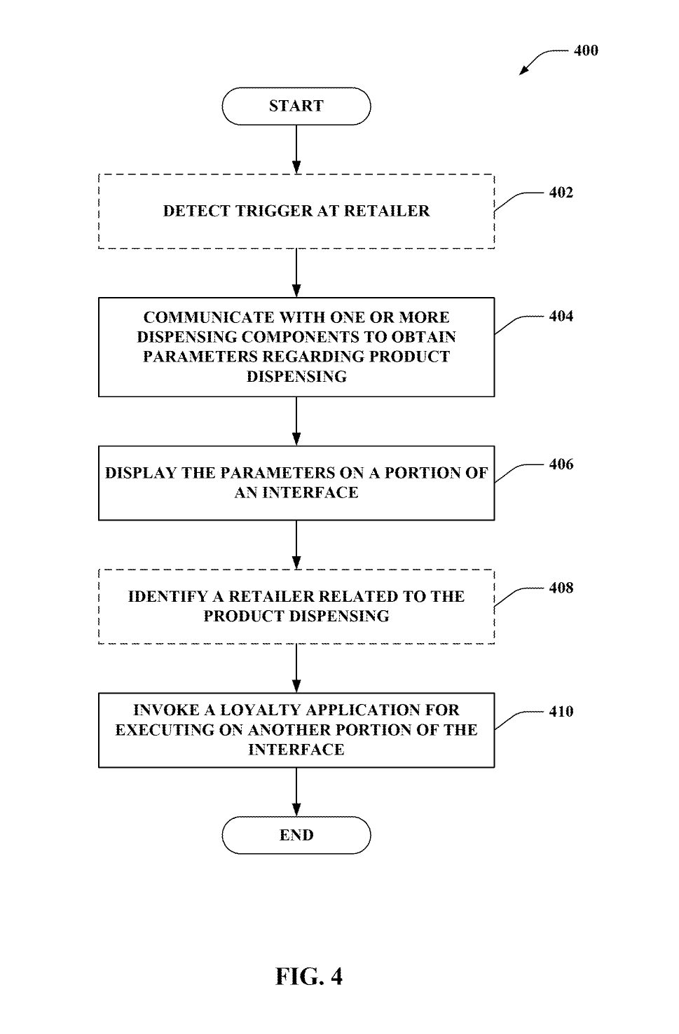

Referring to FIGS. 4-7, methodologies that can be utilized in accordance with various aspects described herein are illustrated. While, for purposes of simplicity of explanation, the methodologies are shown and described as a series of acts, it is to be understood and appreciated that the methodologies are not limited by the order of acts, as some acts can, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

FIG. 4 illustrates an example methodology 400 for managing product dispensing and invoking a loyalty application. Optionally, in some examples, a trigger can be detected at a retailer at 402. For example, this can include detecting a signal transmitted by one or more components at the retailer (e.g., an NFC, Bluetooth, WiFi, etc. signal). In another example, the trigger can be transmitted through one or more networks (e.g., through a cellular network) and detected based at least in part on determining a location to be at or near the retailer. In addition, detecting the trigger can include scanning a QR code or other identifier at the retailer. Moreover, in one example, the trigger can include information regarding the retailer, such as an identifier, a resource identifier for obtaining a loyalty application, and/or the like as described herein.

At 404, one or more dispensing components can be communicated with to obtain parameters regarding product dispensing. For example, the one or more dispensing components can include a product dispenser (e.g., a fuel dispenser), an attendant handheld at an attended dispensing site, one or more devices that communicate with multiple dispensers, and/or the like. The obtained parameters can correspond to product dispensing, such as a selected product, an amount dispensed, a total charge for the amount dispensed, etc.

At 406, the parameters can be displayed on a portion of an interface. For example, the interface can be provided on a personal device, such as a mobile device, vehicle information system, etc., which can display the parameter on part of the interface. For example, the portion of the interface can include one or more regions on the interface dedicated to display content of a master mobile application, as described herein.

At 408, a retailer related to product dispensing may be identified. For instance, the retailer can be identified based at least in part on information received from the trigger at 402, determining a location based on receiving the trigger at 402 (e.g., where the retailer, franchise, etc., is determined from the location), and/or the like. In one example, where a location is determined, it can be compared to a list of locations (e.g., GPS coordinates, street addresses, etc.) of known retailers.

At 410, a loyalty application can be invoked for executing on another portion of the interface. For example, if the retailer is identified, a loyalty application related to the retailer can be identified as well and invoked at 410. If the retailer is not identified, a generic loyalty application can be invoked, as described. The loyalty application can execute on the same interface as the display of dispensing parameters, in an example (e.g., using an emulator, as described). It is to be appreciated that the loyalty application can be interrupted to provide information of the product dispensing, such as discounts, advertising, etc., and/or during processing of payment for the product dispensed, and/or the like.

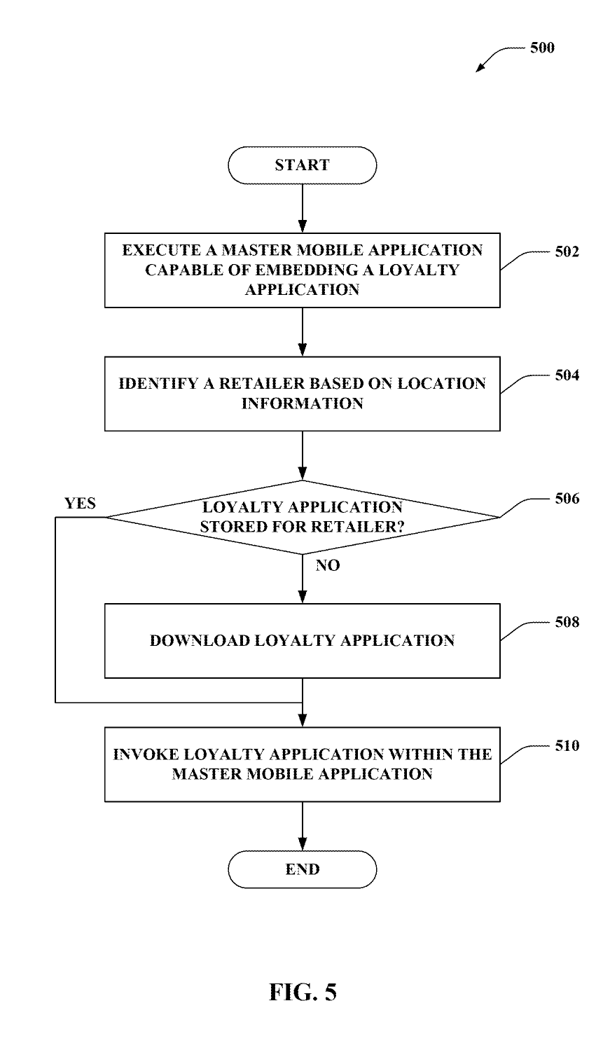

FIG. 5 illustrates an example methodology 500 for invoking a loyalty application within a master mobile application. At 502, a master mobile application capable of embedding a loyalty application can be executed. As described, the master mobile application can be executed using an interface, and a portion of the interface can be used to wrap a loyalty application as well. The master mobile application can execute on a mobile device, vehicle information system, and/or the like, as described.

At 504, a retailer can be identified based on location information. As described, the location information can relate to or otherwise be determined based on a received trigger. In this example, the trigger can include retailer identifying information and/or the retailer can be determined based on a detected location. For example, the location can be detected using one or more positioning systems (e.g., GPS, mobile network triangulation, etc.).

At 506, it can be determined whether a loyalty application is stored for the retailer. For example, this can include determining a loyalty application related to the identified retailer (e.g., based on a retailer identifier determined in identifying the retailer and a related identifier associated with one or more stored loyalty applications). In one example, a mapping table that correlates retailer identifying information to loyalty applications can be accessed to determine whether the loyalty application is stored. Determining whether the loyalty application is stored can include searching for the loyalty application in memory related to the master mobile application (e.g., in a registry or other application identifying listing).

At 508, if the loyalty application is not stored, it can be downloaded. For example, this can include downloading the loyalty application based on a resource identifier determined for the retailer. In an example, where the retailer is identified based on a triggering signal at the retailer, the signal can include instructions or a resource identifier for downloading the loyalty application, whether from a source at the retailer, an app store, and/or the like. In another example, the instructions can include instructions for executing the loyalty application via a source at the retailer on a thin client of the personal device.

At 510, the loyalty application, whether download was required or not, can be invoked within the master mobile application (e.g., using an emulator, as described). Thus, the master mobile application can allow interaction with the loyalty application via an interface, and can interrupt the loyalty application, process input to the loyalty application, process output from the loyalty application, and/or the like, as described herein.

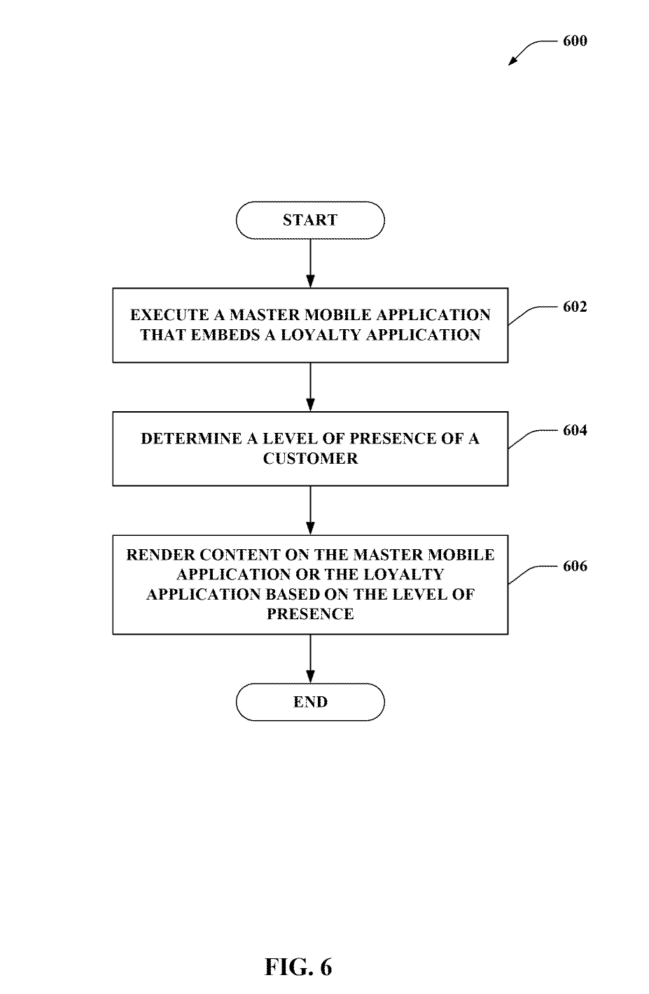

FIG. 6 illustrates an example methodology 600 for rendering content of an application based on a level of customer presence. At 602, a master mobile application that embeds a loyalty application is executed. As described, the master mobile application can control certain aspects of the loyalty application, interrupt the loyalty application, provide information to the loyalty application, and/or the like.

At 604, a level of presence of a customer can be determined. For example, this can include inferring the level of presence based at least in part on input from one or more presence determining devices, such as a camera, proximity sensor, facial recognition, eye gaze tracking, or similar devices. For example, the level of presence can be determined as someone present, whether a face is recognized, whether eye gaze is directed to the device on which the applications execute, and/or the like. In other examples, the level of presence can be determined from input from an accelerometer on the device, certain touch input parameters, detecting closing of a window, initiating or receiving a phone call or text message, and/or the like.

At 606, content can be rendered on the master mobile application or the loyalty application based on the level of presence. For example, where a certain level of presence is detected for a certain amount of time, the content can include discounts or other rewards rendered on the master mobile application for redeeming by the customer for the present or a future product dispensing or at other retailers.

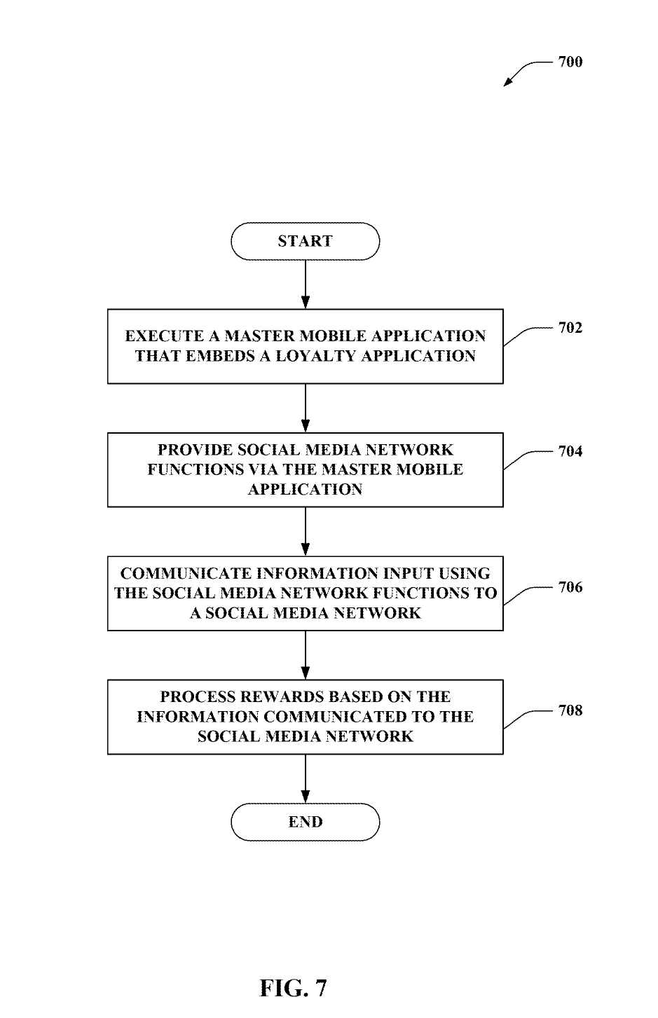

FIG. 7 illustrates an example methodology 700 for dispensing a product according to social media network interaction. At 702, a master mobile application that embeds a loyalty application is executed. As described, the master mobile application can control certain aspects of the loyalty application, interrupt the loyalty application, provide information to the loyalty application, and/or the like.

At 704, social media network functions can be provided via the master mobile application. For instance, the master mobile application can interface with the social media network to allow a customer to post status updates, “like” or otherwise indicate an approval or preference for the retailer, and/or the like via an interface on which the master mobile application executes. At 706, information input using the social media network functions can be communicated to the social media network to effectuate corresponding updates.

At 708, rewards can be processed based on the information communicated to the social media network. Thus, for example, discounts can be awarded for a certain number of “likes” processed at the retailer, a certain number of other people sharing a status update made at the retailer, and/or the like. The discounts can be tracked and awarded by the master mobile application or the social media network, as described herein. In another example, it is to be appreciated that the social media network interfacing sufficient to receive rewards need not occur via the master mobile application (e.g., can occur using one or more personal devices when the customer is not present at the retailer), but can be applied to a transaction using the master mobile application. Moreover, in an example, processing rewards in the social media network may include transferring rewards to other users, to a donation cause, and/or the like, as described.

In accordance with a further embodiment, a master mobile application may be used in conjunction with a cloud-based service such as that described in co-pending application Ser. No. 14/510,874, filed Oct. 9, 2014 and entitled “System and Method Providing Improved User Experience in a Fuel Dispensing Environment” (incorporated fully herein by reference for all purposes). In this regard, one or more cloud servers may communicate with one or more loyalty servers having information about unused loyalty rewards associated with the customer. For example, the customer may be enrolled in multiple loyalty programs with an accumulated balance but which may otherwise remain unused. The master mobile application can be configured to allow the customer to receive a credit for an immediate purchase at the fueling site even if the fueling retailer is otherwise unaffiliated with the purveyor of the loyalty program.

For example, the cloud server may inform the master mobile application that the fueling customer has an accrued reward balance with a particular airline. The airline may desire to allow the customer to deplete the balance through the purchase of unrelated goods or services. For example, the customer can be offered the option of using all or a portion of the airline reward balance to receive an immediate discount (price per unit or flat discount amount) on the purchase of fuel. If the customer selects this discount via the interface rendered by the master mobile device on the personal device, the discount will be applied accordingly. Receipt of the discount may be conditioned on viewing certain advertisements during the fueling process (or at least allowing them to play). The cloud service can then appropriately compensate the fueling retailer for the discount that was applied. In accordance with preferred methodology, the cloud service may receive a commission or other remuneration from the purveyor of the rewards program in order to compensate it for facilitating the transaction.

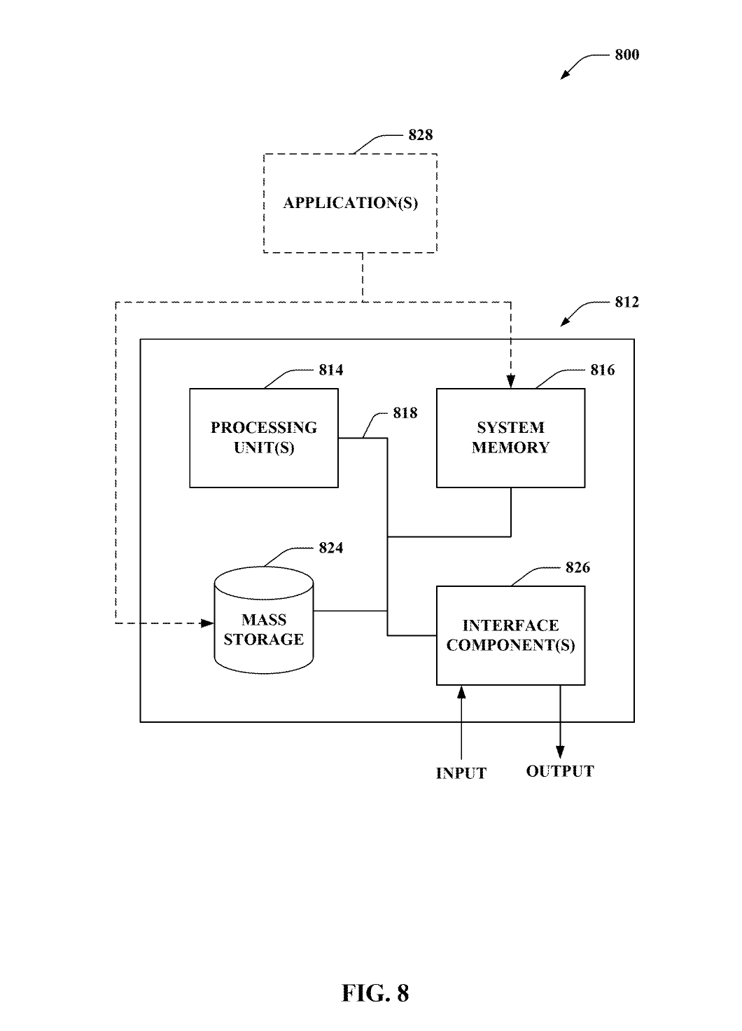

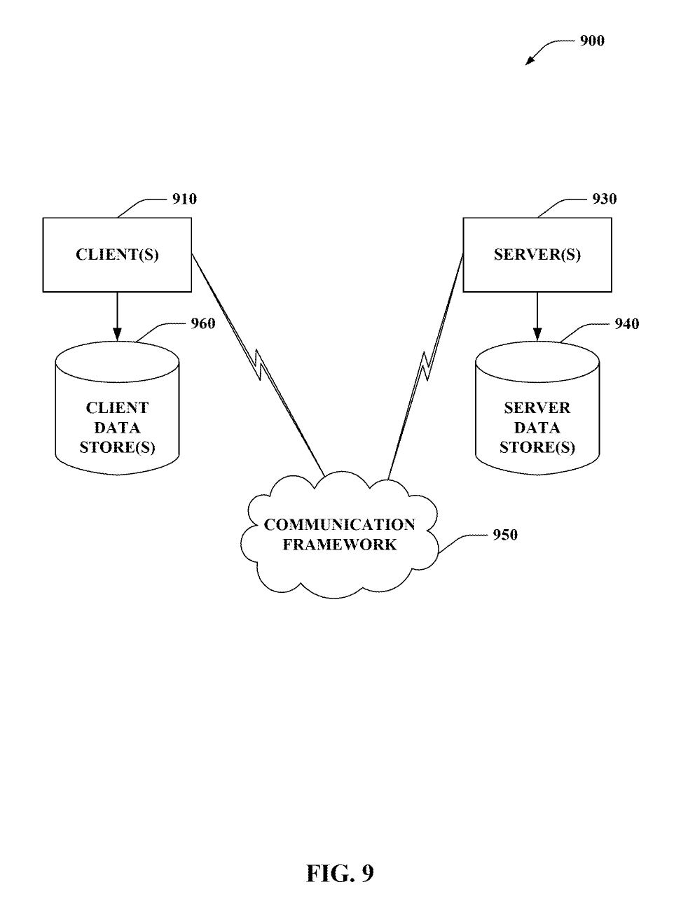

To provide a context for the various aspects of the disclosed subject matter, FIGS. 8 and 9 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 8, an exemplary environment 800 for implementing various aspects disclosed herein includes a computer 812 (e.g., desktop, laptop, server, hand held, programmable consumer or industrial electronics . . . ). The computer 812 includes a processing unit 814, a system memory 816 and a system bus 818. The system bus 818 couples system components including, but not limited to, the system memory 816 to the processing unit 814. The processing unit 814 can be any of various available microprocessors. It is to be appreciated that dual microprocessors, multi-core and other multiprocessor architectures can be employed as the processing unit 814.

The system memory 816 includes volatile and nonvolatile memory. The basic input/output system (BIOS), containing the basic routines to transfer information between elements within the computer 812, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 812 also includes removable/non-removable, volatile/non-volatile computer storage media. FIG. 8 illustrates, for example, mass storage 824. Mass storage 824 includes, but is not limited to, devices like a magnetic or optical disk drive, floppy disk drive, flash memory or memory stick. In addition, mass storage 824 can include storage media separately or in combination with other storage media.

FIG. 8 provides software application(s) 828 that act as an intermediary between users and/or other computers and the basic computer resources described in suitable operating environment 800. Such software application(s) 828 include one or both of system and application software. System software can include an operating system, which can be stored on mass storage 824, that acts to control and allocate resources of the computer system 812. Application software takes advantage of the management of resources by system software through program modules and data stored on either or both of system memory 816 and mass storage 824.

The computer 812 also includes one or more interface components 826 that are communicatively coupled to the bus 818 and facilitate interaction with the computer 812. By way of example, the interface component 826 can be a port (e.g., serial, parallel, PCMCIA, USB, FireWire . . . ) or an interface card (e.g., sound, video, network . . . ) or the like. The interface component 826 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 812 to output device(s) via interface component 826. Output devices can include displays (e.g., cathode ray tube (CRT), liquid crystal display (LCD), light emitting diode (LCD), plasma . . . ), speakers, printers and other computers, among other things.

According to an example, the processing unit(s) 814 can comprise or receive instructions related to executing a master mobile application, loyalty application, and/or other aspects described herein. It is to be appreciated that the system memory 816 can additionally or alternatively house such instructions and the processing unit(s) 814 can be utilized to process the instructions. Moreover, interface component(s) 826 can allow for interacting with content, operating certain functions of the devices described herein, etc., and mass storage 824 can store information for performing the certain functions, such as content, loyalty application registries, etc. System 800, or at least computer 812, can include a personal device 102 or other devices, components, or systems described herein.

FIG. 9 is a schematic block diagram of a sample-computing environment 900 with which the subject innovation can interact. The environment 900 includes one or more client(s) 910. The client(s) 910 can be hardware and/or software (e.g., threads, processes, computing devices). The environment 900 also includes one or more server(s) 930. Thus, environment 900 can correspond to a two-tier client server model or a multi-tier model (e.g., client, middle tier server, data server), amongst other models. The server(s) 930 can also be hardware and/or software (e.g., threads, processes, computing devices). The servers 930 can house threads to perform transformations by employing the aspects of the subject innovation, for example. One possible communication between a client 910 and a server 930 may be in the form of a data packet transmitted between two or more computer processes.

The environment 900 includes a communication framework 950 that can be employed to facilitate communications between the client(s) 910 and the server(s) 930. Here, the client(s) 910 can correspond to program application components and the server(s) 930 can provide the functionality of the interface and optionally the storage system, as previously described. The client(s) 910 are operatively connected to one or more client data store(s) 960 that can be employed to store information local to the client(s) 910. Similarly, the server(s) 930 are operatively connected to one or more server data store(s) 940 that can be employed to store information local to the servers 930.

By way of example, one or more clients 910 can be a personal device 102, rendering content from a master mobile application, loyalty application, etc. Server(s) 930 can include retailer components, social media networking sites, etc., which can communicate with the one or more clients 910 via communication framework 950. The server(s) 930 can, in one example, can facilitate providing discounts or other rewards, processing social media network inputs, etc. to/from the client(s) 910 via communication framework 950.

The various illustrative logics, logical blocks, modules, components, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above. An exemplary storage medium may be coupled to the processor, such that the processor can read information from, and write information to, the storage medium. In the alternative, the storage medium may be integral to the processor. Further, in some aspects, the processor and the storage medium may reside in an ASIC.

In one or more aspects, the functions, methods, or algorithms described may be implemented in hardware, software, firmware, or any combination thereof. If implemented in software, the functions may be stored or transmitted as one or more instructions or code on a computer-readable medium, which may be incorporated into a computer program product. Computer-readable media includes both computer storage media and communication media including any medium that facilitates transfer of a computer program from one place to another. A storage medium may be any available media that can be accessed by a computer. By way of example, and not limitation, such computer-readable media can comprise random access memory (RAM), read-only memory (ROM), electrically erasable programmable ROM (EEPROM), compact disc (CD)-ROM or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While one or more aspects have been described above, it should be understood that any and all equivalent realizations of the presented aspects are included within the scope and spirit thereof. The aspects depicted are presented by way of example only and are not intended as limitations upon the various aspects that can be implemented in view of the descriptions. Thus, it should be understood by those of ordinary skill in this art that the presented subject matter is not limited to these aspects since modifications can be made. Therefore, it is contemplated that any and all such embodiments are included in the presented subject matter as may fall within the scope and spirit thereof.

What is claimed is:

1. A system for managing loyalty applications in fuel dispensing environments, comprising:
an electronic personal device including an interface and at least one processor that executes a master mobile application;
said master mobile application operative to perform at least one of rendering content and accepting input on the interface of the personal device, wherein the master mobile application is configured to:
communicate with one or more dispensing components to obtain parameters regarding product dispensing;
display the parameters on a portion of the interface; and
invoke a loyalty application for executing on another portion of the interface.

2. The system of claim 1, further comprising a trigger detecting component for detecting a location at a retailer, wherein the master mobile application is further configured to identify the retailer based at least in part on the a trigger detecting component detecting the location at the retailer, and wherein the master mobile application invokes the loyalty application based at least in part on identifying the retailer.

3. The system of claim 2, wherein the trigger detecting component detects the location at the retailer based at least in part on receiving a signal from one or more components at the retailer.

4. The system of claim 3, wherein the signal is a near-field communication signal, a Bluetooth signal, or a WiFi signal.

5. The system of claim 3, wherein the signal comprises information identifying the retailer, and wherein the master mobile application identifies the retailer based at least in part on the information.

6. The system of claim 2, wherein the master mobile application is further configured to:
determine whether the loyalty application is stored for the retailer based on identifying the retailer; and
download the loyalty application where the loyalty application is not stored.

7. The system of claim 6, wherein the master mobile application is configured to download the loyalty application from the retailer based at least in part on a signal from the retailer detected by the trigger detecting component.

8. The system of claim 6, wherein the master mobile application is further configured to register a customer with the loyalty application based on one or more stored parameters relating to the customer.

9. The system of claim 1, wherein the master mobile application is further configured to interrupt the loyalty application in the another portion of the interface to render alternative content.

10. The system of claim 9, wherein the alternative content relates to an advertisement or one or more redeemable discounts for the product dispensing.

11. The system of claim 1, further comprising a presence determining device for determining a level of presence of a customer, wherein the master mobile application is configured to render content on the interface based at least in part on the level of presence of the customer.

12. The system of claim 11, wherein the content relates to providing tiered price discounts on the product dispensing based at least in part on the level of presence of the customer.

13. The system of claim 12, wherein the master mobile application is further configured to communicate the tiered price discounts to a dispenser performing the product dispensing.

14. The system of claim 12, wherein the master mobile application is further configured to facilitate redemption of the tiered price discounts by displaying a code on the interface.

15. The system of claim 12, wherein the master mobile application is further configured to facilitate transfer of the tiered price discounts to one or more other customers over a social media network.

16. The system of claim 11, wherein the content relates to providing advertisements on the interface based at least in part on the level of presence of the customer.

17. The system of claim 1, wherein the master mobile application is further configured to communicate with the one or more dispensing components to provide information regarding the product dispensing, wherein the information correlates to one or more stored preference parameters.

18. The system of claim 1, wherein the master mobile application is further configured to communicate with a social media network to provide information for a customer specified via the interface.

19. The system of claim 18, wherein the master mobile application is further configured to obtain one or more rewards for the customer based at least in part on providing the information to the social media network.

21. The system of claim 1, wherein the one or more dispensing components comprise an attendant handheld at an attended dispensing station.

22. The system of claim 1, wherein the master mobile application is further configured to communicate with one or more point-of-sale components to process payment for the product dispensing.

23. The system of claim 22, wherein the master mobile application is configured to communicate to the one or more point-of-sale components one or more parameters received via the portion of the interface related to payment for the product dispensing.

24. The system of claim 1, wherein the master mobile application executes an emulator and is configured to invoke the loyalty application using the emulator.
